(19) United States
(12) Patent Application Publication
(10) Pub. No.: US 2013/0174239 A1
(43) Pub. Date: Jul. 4, 2013

(54) REINFORCED AUTHENTICATION SYSTEM AND METHOD USING CONTEXT INFORMATION AT THE TIME OF ACCESS TO MOBILE CLOUD SERVICE

(71) Applicants: Hwan-Kuk Kim, Seoul (KR); Chang-Yong Lee, Seoul (KR); Jeong-Wook Kim, Ansan (KR); Il-Ahn Cheong, Seoul (KR); Hyun-Cheol Jeong, Seoul (KR)

(72) Inventors: Hwan-Kuk Kim, Seoul (KR); Chang-Yong Lee, Seoul (KR); Jeong-Wook Kim, Ansan (KR); Il-Ahn Cheong, Seoul (KR); Hyun-Cheol Jeong, Seoul (KR)

(73) Assignee: KOREA INTERNET & SECURITY AGENCY, Seoul (KR)

(21) Appl. No.: 13/361,550

(22) Filed: Jan. 30, 2012

(30) Foreign Application Priority Data
Dec. 29, 2011 (KR) 10-2011-0146136

(51) Int. Cl. H04L 9/32; G06F 21/00

(52) U.S. Cl. 726/7

(57) ABSTRACT

Provided are a reinforced authentication system and method using context information at the time of access to a mobile cloud service. The system comprises a mobile terminal transmitting a context information message, which comprises context information, and authentication information and a context information-based authentication server receiving the context information message and the authentication information, determining an authentication mechanism based on the context information message, and authenticating a user of the mobile terminal.

### CROSS-REFERENCE TO RELATED APPLICATION

This application claims priority from Korean Patent Application No. 10-2011-0146136 filed on Dec. 29, 2011 in the Korean Intellectual Property Office, the disclosure of which is incorporated herein by reference in its entirety.

### BACKGROUND OF THE INVENTION

1. Field of the Invention

The present invention relates to a reinforced authentication system and method using context information at the time of access to a mobile cloud service, and more particularly, to a reinforced authentication system and method which applies a different authentication mechanism according to context information of a user when the user accesses a mobile cloud service.

2. Description of the Related Art

With the widespread use of smart phones, many conventional Internet services such as web services, mails and social network services (SNS) have become available in a mobile environment. Accordingly, mobile services including smart office and mobile cloud are being actively provided.

Mobile cloud services refer to all Internet services that can be accessed and used through the Internet using a mobile terminal. Unlike conventional fixed PC-based computing services, mobile cloud services are accessible by a user on the move at anytime and anywhere through various wireless communication networks. Furthermore, with the widespread use of smart phones and tablet PCs, many service users use more than two terminals and can access services through various wireless networks such as 3G and WiFi. Therefore, users can request and use a service through the Internet without being bound to a particular terminal and an access network.

However, the increased use of mobile devices and the increased diversity of the access environment of users have revealed security vulnerabilities such as the loss and theft of mobile devices, the illegal use of accounts, and access to the WiFi network with a low security level. Accordingly, this has led to an increasing demand from company system administrators, who intend to establish a mobile office and a mobile cloud environment, for a reinforced authentication system which applies a different authentication mechanism according to the access and security context of a user.

### SUMMARY OF THE INVENTION

Aspects of the present invention provide a reinforced authentication system and method using context information at the time of access to a mobile cloud service, in which a mobile communication system user is authenticated based on context information that reflects an access environment in which the user accesses the mobile cloud service.

Aspects of the present invention also provide a reinforced authentication system and method using context information at the time of access to a mobile cloud service, in which the number of authentication mechanisms used or the level of an authentication mechanism used is increased according to access context information of a mobile user in order to solve problems of a conventional authentication system which provides a single authentication mechanism without considering an environment in which the user accesses the mobile cloud service.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a reinforced authentication system using context information at the time of access to a mobile cloud service, the system comprising a mobile terminal transmitting a context information message, which comprises context information, and authentication information and a context information-based authentication server receiving the context information message and the authentication information, determining an authentication mechanism based on the context information message, and authenticating a user of the mobile terminal, wherein the context information message comprises a user ID item which identifies the user of the mobile terminal, an Internet protocol (IP)/port item which identifies an IP and port used by the mobile terminal, a time item which identifies a time when the context information was collected, a place item which identifies the location of the mobile terminal, a model name item of the mobile terminal, a terminal ID item of the mobile terminal, an access network item which identifies an access network to which the mobile terminal is connected, and an access network security item which indicates whether the access network applies encryption.

According to an aspect of the present invention, there is provided a reinforced authentication method using context information at the time of access to a mobile cloud service, the method comprising generating a context information message, which comprises context information, by using a mobile terminal, transmitting the context information message to a context information-based authentication server by using the mobile terminal, determining an authentication mechanism based on the context information message by using the context information-based authentication server, receiving authentication information, which corresponds to the authentication mechanism, from the mobile terminal by using the context information-based authentication server and executing authentication based on the authentication information and the authentication mechanism by using the context information-based authentication server, wherein the context information message comprises a user ID item which identifies the user of the mobile terminal, an IP/port item which identifies an IP and port used by the mobile terminal, a time item which identifies a time when the context information was collected, a place item which identifies the location of the mobile terminal, a model name item of the mobile terminal, a terminal ID item of the mobile terminal, an access network item which identifies an access network to which the mobile terminal is connected, and an access network security item which indicates whether the access network applies encryption.

### BRIEF DESCRIPTION OF THE DRAWINGS

The above and other aspects and features of the present invention will become more apparent by describing in detail exemplary embodiments thereof with reference to the attached drawings, in which:

FIGS. 1 and 2 are schematic diagrams of a reinforced authentication system using context information at the time of access to a mobile cloud service according to various embodiments of the present invention;

FIG. 3 is a schematic diagram illustrating the operation of a mobile terminal shown in FIG. 1;

FIG. 4 is a schematic diagram illustrating the operation of a service client module included in the mobile terminal of FIG. 3;

FIG. 5 is a schematic diagram illustrating the operation of a context information collection module included in the mobile terminal of FIG. 3;

FIG. 6 is a schematic diagram illustrating the operation of a session control module included in the mobile terminal of FIG. 3;

FIG. 7 is a flowchart illustrating the operation of the mobile terminal of FIG. 3;

FIG. 8 is a schematic diagram illustrating the operation of a data reception demon included in a context information-based authentication server of FIG. 2;

FIG. 9 is a schematic diagram illustrating the operation of a context information control module of the data reception demon included in the context information-based authentication server of FIG. 2;

FIG. 10 is a flowchart illustrating the operation of the data reception demon included in the context information-based authentication server of FIG. 2

FIG. 11 is a flowchart illustrating the operation of a context information control module included in the data reception demon of the context information-based authentication server of FIG. 2;

FIG. 12 is a schematic diagram illustrating the operation of an authentication policy application demon included in the context information-based authentication server of FIG. 2;

FIG. 13 is a schematic diagram illustrating the operation of a policy adaption (PA)-context module included in the authentication policy application demon of the context information-based authentication server of FIG. 2;

FIG. 14 is a flowchart illustrating the operation of the authentication policy application demon included in the context information-based authentication server of FIG. 2;

FIG. 15 is a schematic diagram illustrating an authentication policy according to an embodiment of the present invention;

FIG. 16 is a schematic diagram illustrating the operation of an authentication execution demon included in the context information-based authentication server of FIG. 2;

FIG. 17 is a schematic diagram illustrating the operation of an authentication execution (AE)-execution module included in the authentication execution demon of the context information-based authentication server of FIG. 2;

FIG. 18 is a flowchart illustrating the operation of the authentication execution demon included in the context information-based authentication server of FIG. 2; and

FIG. 19 is a flowchart illustrating a reinforced authentication method using context information at the time of access to a mobile cloud service according to an embodiment of the present invention.

### DETAILED DESCRIPTION OF EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In the drawings, sizes and relative sizes of elements may be exaggerated for clarity.

Like reference numerals refer to like elements throughout the specification. As used herein, the term “and/or” includes any and all combinations of one or more of the associated listed items.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “made of,” when used in this specification, specify the presence of stated components, steps, operations, and/or elements, but do not preclude the presence or addition of one or more other components, steps, operations, elements, and/or groups thereof.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the present invention

Embodiments of the invention are described herein with reference to plan and cross-section illustrations that are schematic illustrations of idealized embodiments of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

Hereinafter, the present invention will be described in further detail with reference to the accompanying drawings.

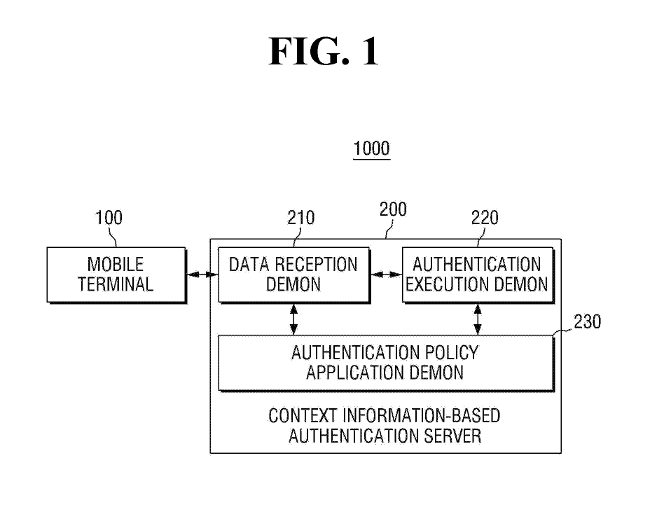

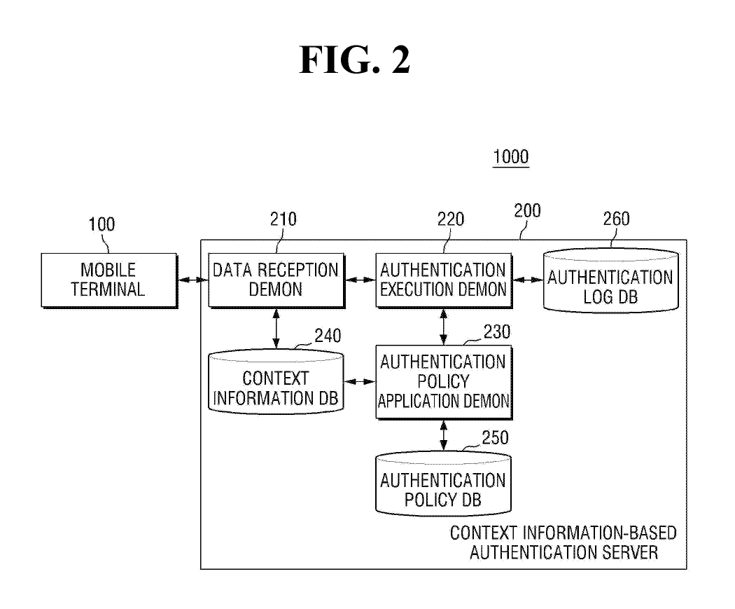

FIGS. 1 and 2 are schematic diagrams of a reinforced authentication system 1000 using context information at the time of access to a mobile cloud service according to various embodiments of the present invention. Referring to FIG. 1, the reinforced authentication system 1000 using context information at the time of access to a mobile cloud service may include a mobile terminal 100 and a context information-based authentication server 200 which includes a data reception demon 210, an authentication execution demon 220, and an authentication policy application demon 230. Referring to FIG. 2, the context information-based authentication server 200 may further include a context information database (DB) 240, an authentication policy DB 250, and an authentication log DB 260.

The mobile terminal 100 may be a movable or portable terminal. In some embodiments, the mobile terminal 100 may be a smart phone or a tablet PC. For simplicity, an embodiment in which the mobile terminal 100 is a smart phone or a tablet PC will be described below. However, the mobile terminal 100 may also be a cellular phone, a notebook computer, a digital broadcasting terminal, a personal digital assistant (PDA), a potable multimedia player (PMP), or a navigation system. The mobile terminal 100 may also be referred to as a mobile cloud authentication-client (MCA-CL).

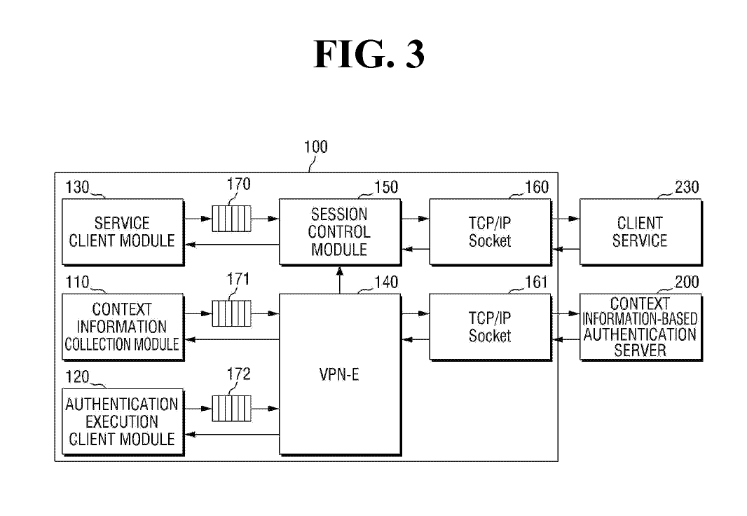

The mobile terminal 100 may collect and send context information of a user and may generate and send authentication information needed to execute authentication. The operation of the mobile terminal 100 will now be described in more detail with reference to FIGS. 3 through 7.

FIG. 3 is a schematic diagram illustrating the operation of the mobile terminal 100 shown in FIG. 2. Referring to FIG. 3, the mobile terminal 100 may include a service client module 130, a context information collection module 110, an authentication execution client module 120, buffers 170 through 172, a virtual private network (VPN)-E module 140, a session control module 150, and transmission control protocol (TCP)/Internet protocol (IP) sockets 160 and 161.

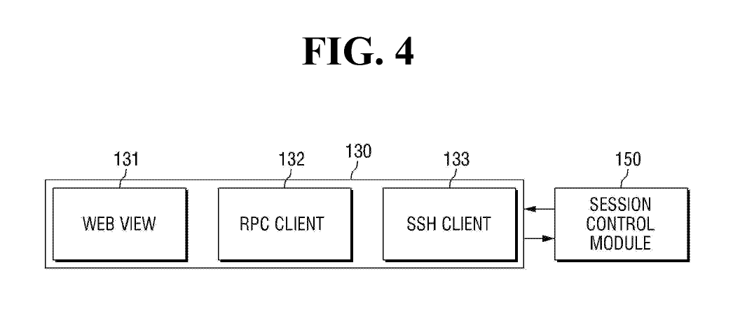

The service client module 130 may provide a service client function needed to actually use a mobile cloud service. In some embodiments, the mobile cloud service may be an infrastructure as a service (IaaS). The operation of the service client module 130 will now be described in more detail with reference to FIG. 4.

FIG. 4 is a schematic diagram illustrating the operation of the service client module 130 included in the mobile terminal 100 of FIG. 3. Referring to FIG. 4, the service client module 130 may include a web view 131 which can be used by a system administrator in a company to use a virtual server management service, a remote procedure call (RPC) client 132 which can be used by a general user to use a Windows server, and a secure shell (SSH) client 133 which can be used by a general user to use a Linux server. When a user of the mobile terminal 100 can use a mobile cloud service, that is, the IaaS, the service client module 130 may communicate with the session control module 150 to enable the user to actually use the service.

Referring back to FIG. 3, the context information collection module 110 may collect context information of a user, generate a context information message, and send the context information message to the context information-based authentication server 200.

The context information refers to information that can reflect an environment in which the user accesses the mobile cloud service to use the mobile cloud service. The context information message generated in the form of a message to deliver this context information may include a user ID item which identifies the user of the mobile terminal 100, an IP/port item which identifies an IP and port used by the mobile terminal 100, a time item which identifies a time when the context information was collected, a place item which identifies the location of the mobile terminal 100, a model name item of the mobile terminal 100, a terminal ID item of the mobile terminal 100, an access network item which identifies an access network to which the mobile terminal 100 is connected, and an access network security item which indicates whether the access network applies encryption. In the present specification, the context information and the context information message are defined as different terms. However, they can be used as terms having the same meaning.

The user ID item includes information related to an identifier that can identify each user. The user ID item may be, for example, a unique ID defined for each user.

The IP/port item may include information about an IP/port through which the mobile terminal 100 of a user is transmitting data to use the mobile cloud service. The model name item may be used to identify the mobile terminal 100 of the user. The model name item may identify a model name given by a manufacturer of the mobile terminal 100. The terminal ID item may denote a unique identifier or a serial number given in advance by the context information-based authentication server 200 to identify the mobile terminal 100.

Only an authorized mobile terminal 100 should be allowed to access the mobile cloud service which deals with important information of a company such as smart office, and a user should be associated with the mobile terminal 100 for the use of the mobile cloud service. Since such functional support is required for the use of the mobile cloud service, unique identifier information of the mobile terminal 100 should be collected. In addition, the mobile terminal 100 varies in its type, and each terminal has different computing performance. Thus, information related to the mobile terminal 100 is required to apply the mobile cloud service according to the performance of each terminal. In the reinforced authentication system 1000 using context information at the time of access to a mobile cloud service according to the embodiments of the present invention, since the context information includes items about the mobile terminal 100 itself, the above requirement can be satisfied.

The time item may include information used to identify a time when the context information was collected. In some embodiments, the time item may further include information needed to identify a time when the context information message was transmitted to the context information-based authentication server 200.

It is required to analyze a pattern of times when a user usually accesses the mobile cloud service and apply a different authentication or security mechanism to a person who accesses the mobile cloud service at a time different from the usual times. Since the reinforced authentication system for a mobile communication system according to the embodiments of the present invention collects the time item related to a time when a user attempts to access the mobile cloud service, it can apply a different authentication and security mechanism according to the time.

The place item may include information needed to identify the location of a current user of the mobile terminal 100 and the location of the mobile terminal 100.

It is required to analyze places in which a user usually accesses the mobile cloud service and apply a different authentication or security mechanism to a user who accesses the mobile cloud service from an abnormal place, for example, from a place other than a residence or from a foreign country. The reinforced authentication system 1000 using context information at the time of access to a mobile cloud service according to the embodiments of the present invention collects the place item related to a place in which a user and the mobile terminal 100 attempt to access the mobile cloud service. Thus, the reinforced authentication system 1000 can apply a different authentication and security mechanism according to the location of the user.

The access network item may include information needed to identify an access network to which the mobile terminal 100 is connected. For example, the access network item may be used to identify whether the type of the access network is 3G, WiFi, Wibro, long-term evolution (LTE), or something else. The access network security item may include information indicating whether an access network applies encryption. The access network security item may identify an encryption method used to communicate with an access point (AP) of a WiFi network to which the mobile terminal 100 is currently connected. The access network security item may identify, for example, no security setting, wired equivalent privacy (WEP), WiFi protected access (WPA), WiFi protected access II (WPA2), universal subscriber identity module (USIM), or anything else.

When the access network item identifies the WiFi network, that is, when an access network to which the mobile terminal 100 is currently connected is the WiFi network, the context information message may further include a service set identifier (SSID) item which identifies an SSID of the WiFi network.

The mobile cloud service is accessible through various access networks such as 3G, WiFi, and wired Internet. Each access network may have different security safety (e.g., different authentication and encryption settings) and may provide a different type of mobile cloud service. Therefore, information about the type and security setting state of each access network should be collected to apply a different authentication and security mechanism according to the safety of each access network. The reinforced authentication system 1000 using context information at the time of access to a mobile cloud service according to the embodiments of the present invention collects information about the type of each access network to which the mobile terminal 100 is connected and the security setting information of each access network. Thus, the reinforced authentication system 1000 can apply a different authentication and security mechanism according to an access network used by the mobile terminal 100 of a user.

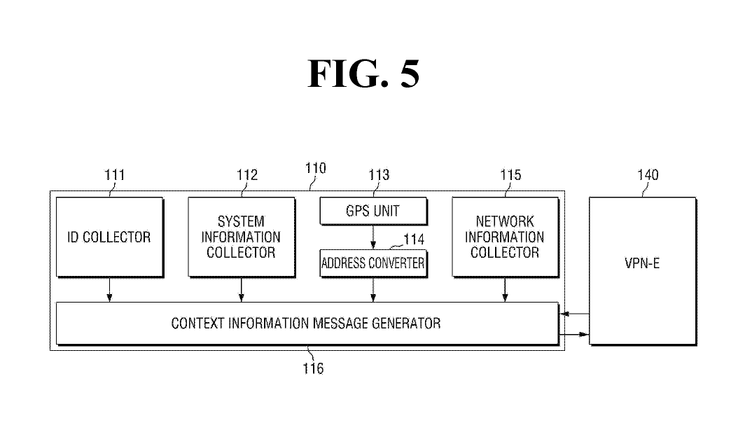

The operation of the context information collection module 110 and the way that the context information collection module 110 collects context information will now be described in more detail with reference to FIG. 5.

FIG. 5 is a schematic diagram illustrating the operation of the context information collection module 110 included in the mobile terminal 100 of FIG. 3. Referring to FIG. 5, the context information collection module 110 may include an ID collector 111, a system information collector 112, a global positioning system (GPS) unit 113, an address converter 114, a network information collector 115, and a context information message generator 116.

The ID collector 111 may collect information related to a user. For example, the ID collector 111 may collect information related to the user ID item of the context information message and information related to the IP/port item of the context information message and may send the collected information to the context information message generator 116.

The system information collector 112 may collect information about the overall system, such as information about a current time and information related to the mobile terminal 100. For example, the system information collector 112 may collect information related to the IP/port item, information related to the model name item, information related to the terminal ID item, and information related to the time item in the context information message and may send the collected information to the context information message generator 116. In some embodiments, the system information collector 112 may further collect information which can identify a serial number given to the mobile terminal 100 by the manufacturer of the mobile terminal 100, information which can identify the name of the manufacturer of the mobile terminal 100, information which can identify a central processing unit (CPU) model name of the mobile terminal 100, information which can identify the memory capacity of the mobile terminal 100, and information which can identify the operating system (OS) name and version of the mobile terminal 100.

The GPS unit 113 may collect information related to the current location of the mobile terminal 100 using a GPS function. For example, the GPS unit 113 may collect GPS coordinates and send the collected information to the context information message generator 116. In some embodiments, it may be difficult to determine the exact location of the mobile terminal 100 with the GPS coordinates only. Thus, the GPS coordinates may need to be converted into an address in a text format, e.g., an address written in order of house number, neighborhood name, city name, and country name. To this end, the GPS unit 113 may transmit the GPS coordinates to the address converter 114. Accordingly, the address converter 114 may convert the GPS coordinates into an address in a text format and send the address in the text format to the context information message generator 116.

The network information collector 115 may collect information related to an access network to which the mobile terminal 100 is connected. For example, the network information collector 115 may collect information related to the access network item, information related to the access network security item, and information related to the SSID item in the context information message and may send the collected information to the context information message generator 116.

The context information message generator 116 may generate a context information message based on the information received from the ID collector 111, the system information collector 112, the GPS unit 113, the address converter 114, and the network information collector 115. The context information message generator 116 may put together the information received from the ID collector 111, the system information collector 112, the GPS unit 113, the address converter 114, and the network collector 115 and enter corresponding information in each of the user ID item, the IP/port item, the time item, the place item, the model name item, the terminal ID item, the access network item, the access network security item and the SSID item of the context information message. The context information message generator 116 may transmit the generated context information message to the VPN-E module 140 in order to transmit the generated context information message to the context information-based authentication server 200. In some embodiments, a transmission interval of the context information message may be set to 60 seconds by default. The transmission interval of the context information message can vary. The variation in the transmission interval will be described in greater detail later.

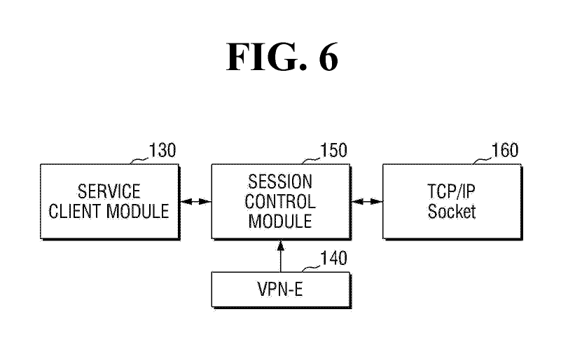

Referring back to FIG. 3, the session control module 150 may terminate a session when the context information-based authentication server 200 fails to authenticate a user or when the result of context information analysis requires the termination of the session. The operation of the session control module 150 will now be described in more detail with reference to FIG. 6.

FIG. 6 is a schematic diagram illustrating the operation of the session control module 150 included in the mobile terminal 100 of FIG. 3.

When the context information-based authentication server 200 fails to authenticate a user or when the result of context information analysis requires the termination of a session, the context information-based authentication server 200 may transmit a session termination request message to the mobile terminal 100 so as to terminate the session. When the mobile terminal 100 receives the session termination request message, the VPN-E module 140 of the mobile terminal 100 may transmit the session termination request message to the session control module 150. In usual situations, the session control module 150 bypasses a packet. However, when receiving the session termination request message, the session control module 150 may terminate the session, thereby ending packet exchange between the TCP/IP sockets 160 and 161 and the service client module 130.

Referring back to FIG. 3, the authentication execution client module 120 may generate authentication information needed by the context information-based authentication server 200 to execute authentication. As will be described later, the context information-based authentication server 200 may request the mobile terminal 100 to provide information about a corresponding authentication mechanism based on a context information message. In this case, the authentication execution client module 120 of the mobile terminal 100 may generate authentication information which is information about the authentication mechanism. In some embodiments, the authentication information may include information about an ID/password (PW), information about a public key infrastructure (PKI) certificate, and information about a security card such as one-time password (OTP). In some other embodiments, the authentication information may include the result of ID/PW-based authentication execution, the result of PKI certificate-based authentication execution, and the security card-based authentication execution.

The VPN-E module 140 may encrypt a packet, which includes a context information message generated by the context information collection module 110 and authentication information generated by the authentication execution client module 120, for the sake of security before transmitting the context information message and the authentication information to the context information-based authentication server 200. In addition, when receiving an encrypted packet which includes information and a message from the context information-based authentication server 200, the VPN-E module 140 may decrypt the encrypted packet.

The mobile terminal 100 may include the TCP/IP sockets 160 and 161 to communicate with the context information-based authentication server 200 or a service which provides a mobile cloud service such as a cloud service. Although not shown in FIGS. 4 through 6 for the sake of simplicity, the mobile terminal 100 may include the buffers 170 through 172 for communication between the service client module 130 and the session control module 150, communication between the context information collection module 110 and the VPN-E module 140, and communication between the authentication execution client module 120 and the VPN-E module 140.

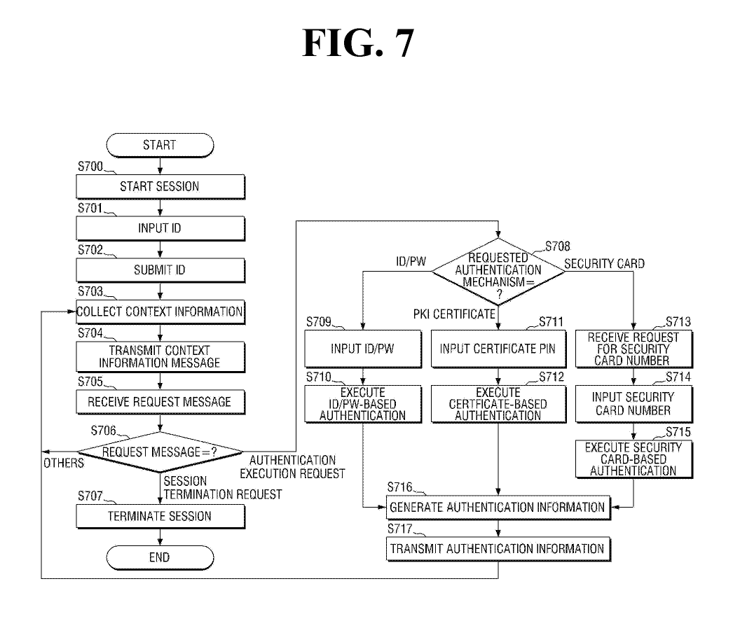

FIG. 7 is a flowchart illustrating the operation of the mobile terminal 100 of FIG. 3. The operation of the mobile terminal 100 described above with reference to FIGS. 3 through 6 will now be described in greater detail with reference to FIG. 7.

Referring to FIG. 7, the mobile terminal 100 may start a session to communicate with the context information-based authentication server 200 or a server which provides a mobile cloud service such as a cloud service (operation S700). When the session starts, a user may input an ID (operation S701), and the input ID may be submitted (operation S702). Then, the mobile terminal 100 may collect context information using the context information collection module 110 and transmit a context information message which includes the collected context information to the context information-based authentication server 200 (operation S704). The mobile terminal 100 may receive an authentication execution request message or a session termination request message from the context information-based authentication server 200 (operation S705). When receiving the session termination request message (operation S706), the mobile terminal 100 may terminate the session (operation S707). When receiving the authentication execution request message (operation S706), the mobile terminal 100 may perform a procedure for generating authentication information.

The mobile terminal 100 may analyze the authentication execution request message and identify an authentication mechanism requested by the context information-based authentication server 200 based on the analysis result (operation S708). When the requested authentication mechanism is ID/PW, the mobile terminal 100 may receive an ID/PW (operation S709) and execute ID/PW-based authentication (operation S710). When the requested authentication mechanism is a PKI certificate, the mobile terminal 100 may receive a personal identification number (PIN) (operation S711) and execute PKI certificate-based authentication (operation S712). When the requested authentication mechanism is a security card such as OTP, the mobile terminal 100 may receive a security card number request (operation 713), receive a security card number (operation S714), and then execute security card-based authentication (operation S715). Subsequently, the authentication execution client module 120 of the mobile terminal 100 may generate authentication information based on received information and/or the result of authentication execution (operation S716) and transmit the generated authentication information to the context information-based authentication server 200 (operation S717).

Referring back to FIGS. 1 and 2, the context information-based authentication server 200 may receive a context information message and authentication information from the mobile terminal 100, determine an authentication mechanism based on the context information message, and authenticate a user of the mobile terminal 100. The context information-based authentication server 200 includes the data reception demon 210, the authentication execution demon 220, and the authentication policy application demon 230. The context information-based authentication server 200 may further include the context information DB 240 which stores context information messages, the authentication policy DB 250 which stores authentication policies, and the authentication log DB 260 which stores authentication results.

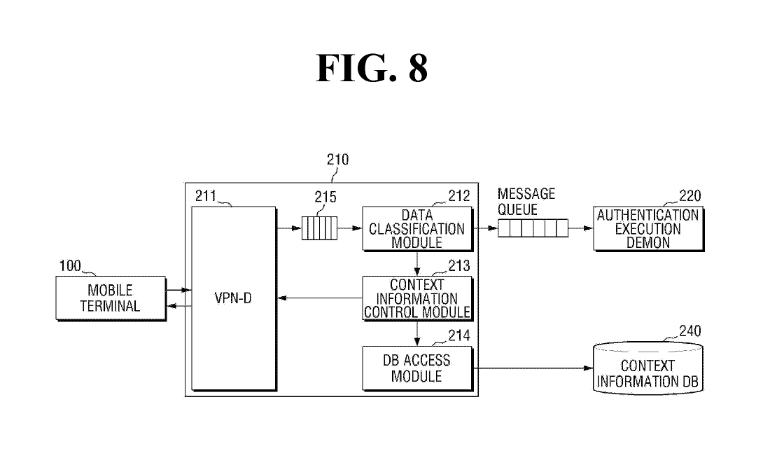

The data reception demon 210 may receive a context information message and authentication information from the mobile terminal 100. In the present specification, the data reception demon 210 may also be referred to as mobile cloud authentication—data receive (MCA-DR). The operation of the data reception demon 210 will now be described in more detail with reference to FIG. 8.

FIG. 8 is a schematic diagram illustrating the operation of the data reception demon 210 included in the context information-based authentication server 200 of FIG. 2. Referring to FIG. 8, the data reception demon 210 may include a VPN-D module 211, a data classification module 212, a context information control module 213, a DB access module 214, and a buffer 215.

The mobile terminal 100 encrypts all packets to be transmitted to the context information-based authentication server 200 and transmits the encrypted packets through a secure sockets layer (SSL)/VPN. Thus, the VPN-D module 211 may decrypt received data. In addition, the VPN-D module 211 may encrypt a packet (including a message and information) which is to be transmitted from the context information-based authentication server 200 to the mobile terminal 100.

The data classification module 212 may sort a context information message and authentication information received from the mobile terminal 100. The context information message received from the mobile terminal 100 may be used to determine an authentication mechanism, together with an authentication policy. On the other hand, the authentication information is used in actual authentication execution. Therefore, the data classification module 212 may sort the content information message and the authentication information. The data classification module 212 may transmit the authentication information to the authentication execution demon 220. In this case, the authentication information transmitted from the data classification module 212 may be temporarily stored in a message queue. The data classification module 212 may transmit the context information message to the context information control module 213 before storing the context information message in a DB.

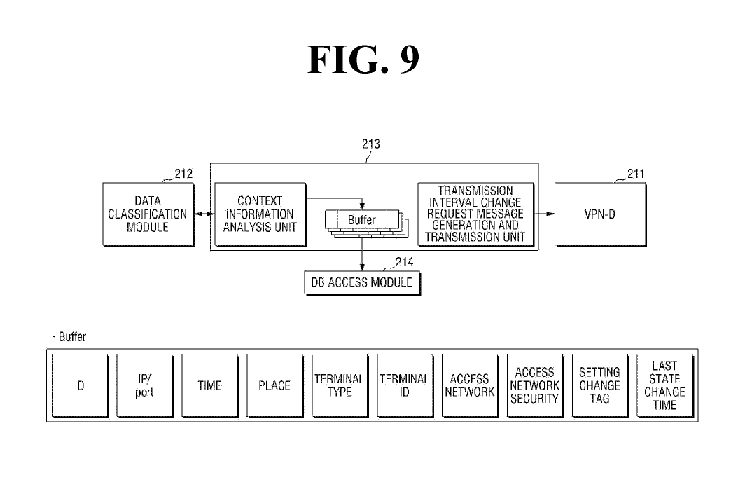

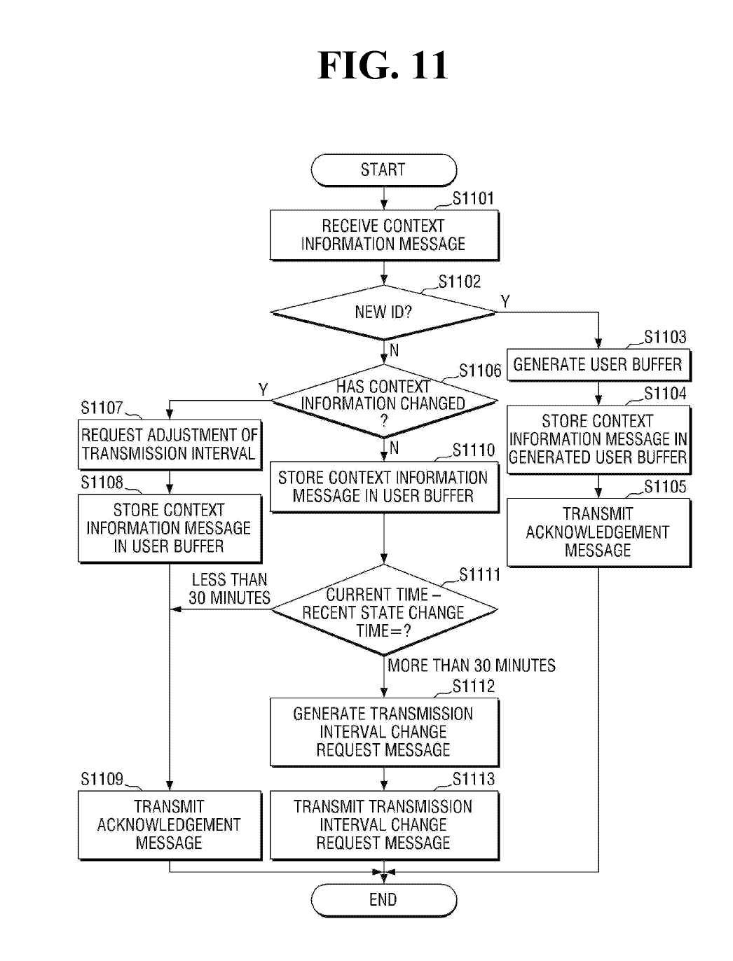

The context information control module 213 may generate a transmission interval change request message when the transmission interval of a context information message needs to be adjusted and transmit the transmission interval change request message for the context information message to the mobile terminal 100. In some embodiments, if there is no difference between, except for the time item, items of the received context information message and those of a previously received context information message for a predetermined period of time, the context information control module 213 may transmit the transmission interval change request message for the context information message to the mobile terminal 100. The operation of the context information control module 213 will now be described in more detail with reference to FIGS. 9 and 11.

FIG. 9 is a schematic diagram illustrating the operation of the context information control module 213 of the data reception demon 210 included in the context information-based authentication server 200 of FIG. 2. FIG. 11 is a flowchart illustrating the operation of the context information control module 213 included in the data reception demon 210 of the context information-based authentication server 200 of FIG. 2. Referring to FIG. 9, the context information control module 213 may include a context information analysis unit, buffers, and a transmission interval change request message generation and transmission unit.

The context information control module 213 may receive a context information message from the data classification module 212 (operation S1101). Then, the context information analysis unit may analyze the context information message and determine whether a user ID in the context information message is a new user ID (operation S1102). When the user ID is a new user ID, the context information control module 213 may generate a new user buffer (operation S1103), store the context information message in the generated user buffer (operation S1104), and transmit an acknowledgement message for informing successful message reception to the mobile terminal 100 (operation S1105). In some embodiments, if the context information control module 213 fails to receive the context information message successfully or if it is hard to identify the content of the context information message although the context information message was received successfully, the context information control module 213 may generate a retransmission request message and transmit the retransmission request message to the mobile terminal 100.

When the user ID is not a new user ID, the context information analysis unit of the context information control module 213 may determine whether there is a difference between items of the context information message and those of a previously received context information message, except for the time item (operation S1106). If there is a difference, the context information analysis unit of the context information control module 213 may check the most recently received context information message and a state change tag (indicating a state change) for a corresponding user by using the user ID as an index (operation S1107). Then, the context information analysis unit may store the context information message in a user buffer (operation S1108) and transmit an acknowledgement message for informing successful message reception to the mobile terminal 100 (operation S1109). If there is no difference, the transmission interval of the context information message may need to be adjusted. In this case, the context information analysis unit of the context information control module 213 may store the most recently received information message in the user buffer by using the user ID as an index before determining whether the transmission interval needs to be adjusted (operation S1110). Then, the context information analysis unit of the context information control module 213 may compare a current time with a recent state change time of context information messages corresponding to the user ID of the context information message and determine whether a predetermined time has passed from the recent state change time (operation S1111). In some embodiments, the predetermined time may be 30 minutes or may be set to a different value. When 30 minutes have not passed from the recent state change time, the context information control module 213 may transmit an acknowledgement message for informing successful message reception to the mobile terminal 100 without requiring an acknowledgement request message (operation S1109). However, when more than 30 minutes have passed from the recent state change time, the transmission interval change request generation and transmission unit may generate a transmission interval change request message for requesting a change in the transmission interval (operation S1112) and transmit the generated transmission interval change request message to the mobile terminal 100 (operation S1113). In some embodiments, the transmission interval change request message may be used to request the transmission interval to be changed from 1 minute to 5 minutes. The transmission interval can also be changed to a different value.

While a user is using a mobile cloud service, context information of the user may be changed frequently. Therefore, collected context information should be transmitted periodically from when the user logs into the mobile cloud service to when the user logs out of the mobile cloud service. However, although the context information of the user remains unchanged, if the same context information is repeatedly transmitted periodically, system resources may be wasted. Thus, the reinforced authentication system 1000 using context information at the time of access to a mobile cloud service increases the transmission interval of a context information message when there is no change in context information for a predetermined period of time, thereby reducing the waste of system resources.

Referring back to FIG. 8, the data reception demon 210 may include the DB access module 214 which receives a context information message from the context information control module 213 and stores the context information message in the context information DB 240. In addition, the data reception demon 210 may include the buffer 215 for communication between the VPN-D module 211 and the data classification module 212.

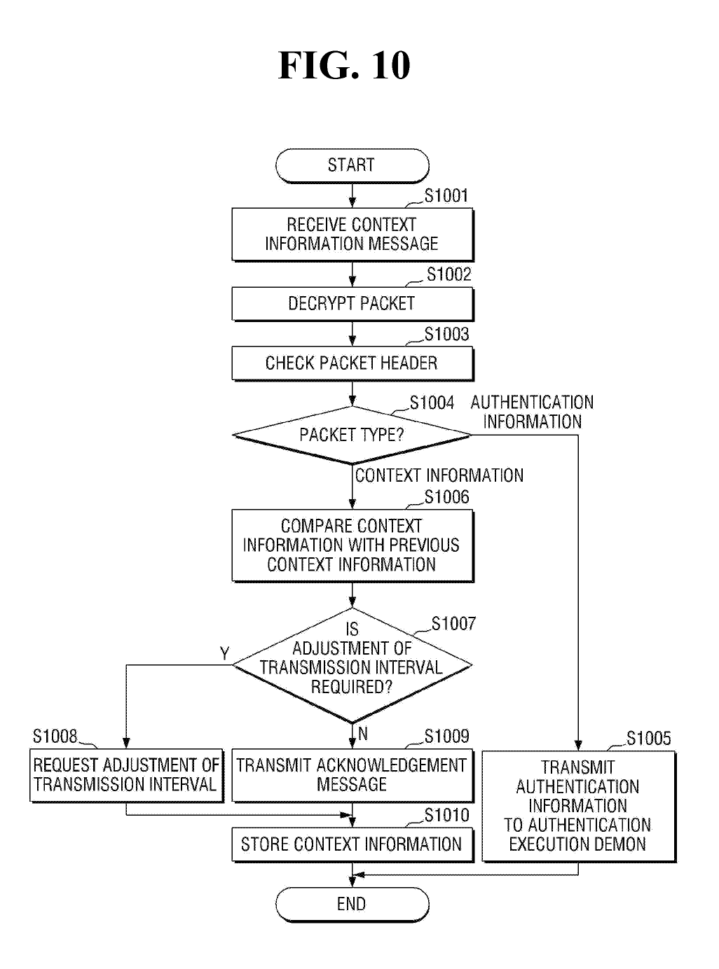

FIG. 10 is a flowchart illustrating the operation of the data reception demon 210 included in the context information-based authentication server 200 of FIG. 2. The operation of the data reception demon 210 described above with reference to FIGS. 8, 9 and 11 will now be described in greater detail with reference to FIG. 10.

Referring to FIG. 10, the data reception demon 210 may receive a packet which includes a context information message and authentication information from the mobile terminal 100 (operation S1001). The packet transmitted from the mobile terminal 100 may be encrypted. Thus, the data reception demon 210 may decrypt the received packet when necessary (operation S1002). The data reception demon 210 may check a header of the packet (operation S1003) to determine whether the received packet is for context information or authentication information (operation S1004). If the received packet is for the authentication information, the data reception demon 210 may transmit the authentication information to the authentication execution demon 220 (operation S1005). If the received packet is for the context information, the data reception demon 210 may compare the currently received context information with previously received context information (operation S1006) and determine whether the adjustment of the transmission interval is required using the method illustrated in the flowchart of FIG. 11 (operation S1007). If the adjustment of the transmission interval is not required, the data reception demon 210 may transmit an acknowledgement message to the mobile terminal 100 (operation S1009) and store the context information (operation S1010). If the adjustment of the transmission interval is required, the data reception demon 210 may generate a transmission interval change request message and transmit the generated transmission interval change request message to the mobile terminal 100 (operation S1008) and store the context information (operation S1010).

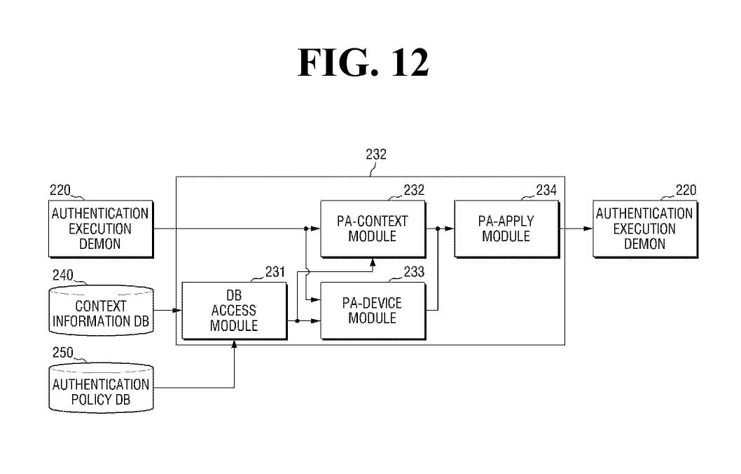

Referring back to FIGS. 1 and 2, the authentication policy application demon 230 may determine an authentication mechanism based on a context information message and an authentication policy. In the present specification, the authentication policy application demon 230 may also be referred to as mobile cloud authentication—policy adaption (MCA-PA). The operation of the authentication policy application demon 230 will now be described in more detail with reference to FIG. 12.

FIG. 12 is a schematic diagram illustrating the operation of the authentication policy application demon 230 included in the context information-based authentication server 200 of FIG. 2. Referring to FIG. 12, the authentication policy application demon 230 may include a PA-context module 232, a PA-device module 233, a PA-apply module 234, and a DB access module 231.

The DB access module 231 may access the context information DB 240 to obtain a context information message and may access the authentication policy DB 250 to obtain an authentication policy. The DB access module 231 may transmit the obtained context information and authentication information to the PA-context module 232 and/or the PA-device module 233.

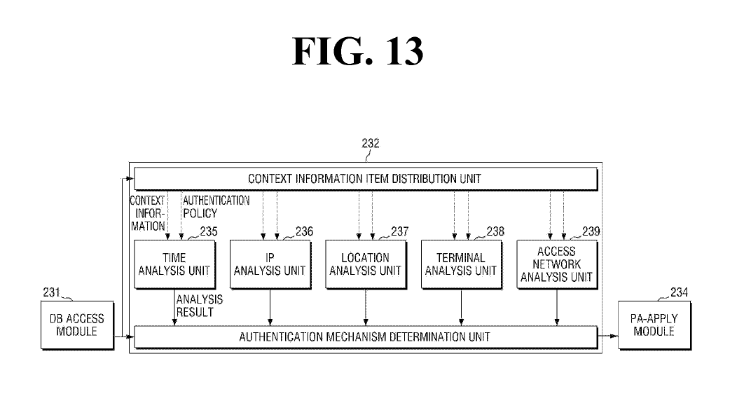

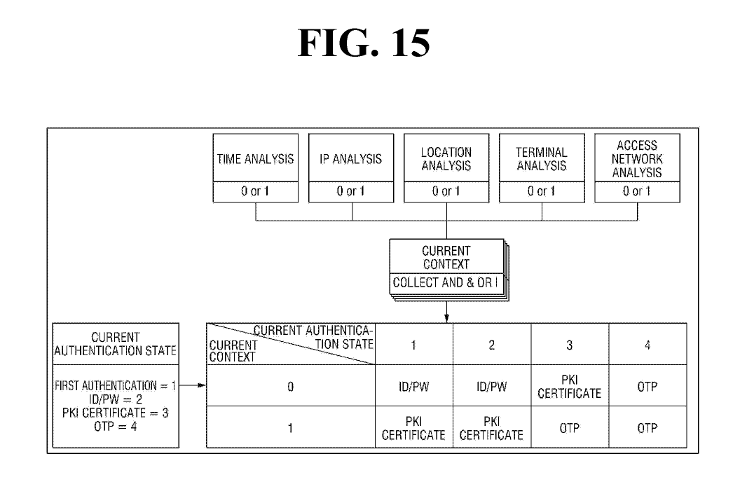

The PA-context module 232 may determine an authentication mechanism based on a context information message, which contains context information, and an authentication policy. The PA-context module 232 may determine a final authentication mechanism based on a combination of the result of determining the safety of a current context by analyzing each item of the context information of a user and information about a current authentication state which denotes an authentication method used by the user to log in. The PA-context module 232 will now be described in more detail with reference to FIGS. 13 and 15.

FIG. 13 is a schematic diagram illustrating the operation of the PA-context module 232 included in the authentication policy application demon 230 of the context information-based authentication server 200 of FIG. 2. FIG. 15 is a schematic diagram illustrating an authentication policy according to an embodiment of the present invention. Referring to FIG. 13, the PA-context module 232 may include a context information item distribution unit, a time analysis unit 235, an IP analysis unit 236, a location analysis unit 237, a terminal analysis unit 238, an access network analysis unit 239, and an authentication mechanism determination unit.

The context information item distribution unit of the PA-context module 232 may receive a context information message and an authentication policy from the DB access module 231. The authentication policy may be defined in the form of detection rules which are basically similar to those of network attack detection. The authentication policy may include, for example, start and end times of an unallowed time range, an IP whitelist and an IP blacklist, a place whitelist and a place blacklist, a terminal whitelist and a terminal blacklist, and an access network whitelist and an access blacklist.

The context information item distribution unit may classify the received context information message and authentication policy according to each item and transmit the items to the time analysis unit 235, the IP analysis unit 236, the location analysis unit 237, the terminal analysis unit 238, and the access network analysis unit 239. For example, the context information item distribution unit may transmit the time item of the context information message and information about the start and end times of the unallowed time range of the authentication policy to the time analysis unit 235, the IP/port item of the context information message and the IP whitelist and IP blacklist of the authentication policy to the IP analysis unit 236, the place item of the context information message and the place whitelist and place blacklist of the authentication policy to the location analysis unit 237, the model name item and terminal ID item of the context information message and the terminal whitelist and terminal black list of the authentication policy to the terminal analysis unit 238, and the access network item, access network security item and SSID item of the context information message and the access network whitelist and access network blacklist of the authentication policy to the access network analysis unit 239. Here, a whitelist refers to a list that can be determined to indicate a safe context (situation), and a blacklist refers to a list that can be determined to indicate a threat context (situation).

The time analysis unit 235 may set a time period during which an ordinary user does not access a mobile cloud service as an unallowed time range and determine a user who accesses the mobile cloud service in this time period as a threat. If a time identified by the time item of the context information message is between the start and end times of the unallowed time range, the time analysis unit 235 may determine that the time indicates the threat context and output one to the authentication mechanism determination unit. If the time identified by the time item of the context information message is outside the unallowed time range, the time analysis unit 235 may determine that the time indicates the safe context and output zero to the authentication mechanism determination unit.

If an IP identified by the IP/port item of the context information message is on the IP whitelist, the IP analysis unit 236 may determine that the IP indicates the safe context and output zero to the authentication mechanism determination unit. In addition, if the IP/port item identifies an access not from an effective domestic IP but from a foreign IP or when an IP identified by the IP/port item is on the IP blacklist, the IP analysis unit 236 may determine that the IP indicates the threat context and output one to the authentication mechanism determination unit.

If a place identified by the place item of the context information message is on the place whitelist, the location analysis unit 237 may determine that the place indicates the safe context and output zero to the authentication mechanism determination unit. In addition, if the place identified by the place item of the context information message is on the place blacklist or if the place identified by the place item is not on the place whitelist when checked five minutes from a current time, the location analysis unit 237 may determine that the place indicates the threat context and output one to the authentication mechanism determination unit.

The terminal analysis unit 238 may analyze the model name item and terminal ID item of the context information message. Based on the analysis result, the terminal analysis unit 238 may determine an unauthorized terminal to be the threat context and output one to the authentication mechanism determination unit and determine an authorized terminal to be the safe context and output zero to the authentication mechanism determination unit. In some embodiments, a list of authorized terminals may be the terminal whitelist, and a list of unauthorized terminals may be the terminal blacklist.

The access network analysis unit 239 may analyze the access network item, access network security item, and SSID item of the context information message. Based on the analysis result, the access network analysis unit 239 may determine an unauthorized access network to be the threat context and output one to the authentication mechanism determination unit and may determine an authorized access network to be the safe context and output zero to the authentication mechanism determination unit. In some embodiments, a list of authorized access networks may be the access network whitelist, and a list of unauthorized access networks may be the access network blacklist. In addition, in some embodiments, an access network which does not use encryption may be determined to be the threat context.

The authentication mechanism determination unit may analyze a current context based on the analysis results received from the time analysis unit 235, the IP analysis unit 236, the location analysis unit 237, the terminal analysis unit 238, and the access network analysis unit 239. The authentication mechanism determination unit may determine whether the current context is the safe context or the threat context by analyzing one or more of the five analysis results received from the time analysis unit 235, the IP analysis unit 236, the location analysis unit 237, the terminal analysis unit 238, and the access network analysis unit 239.

When the authentication policy includes only one of time analysis, IP analysis, location analysis, terminal analysis, and access network analysis, the result of the corresponding analysis may be the analysis result of the current context. That is, when the authentication policy includes a policy only for time analysis, the authentication mechanism determination unit may receive the result of determining whether the time item is within the unallowed time range from the time analysis unit 235 and determine whether the current context is the threat context or the safe context based on the received result represented by zero or one.

When the authentication policy requires only one analysis, the current context can be determined simply as described above. However, the authentication policy usually requires five analyses. In this case, the authentication mechanism determination unit may combine result items received from the analysis units by using an AND (&) operation or an OR (|) operation and classify the current context as the safe context or the threat context. This may be called first analysis. In some embodiments, the authentication mechanism determination unit may perform the AND operation or the OR operation again on results of the first analysis and classify the current context as the safe context or the threat context. This may be called second analysis. The second analysis is performed when the context of a user is too complicated to be determined based on the first analysis only. Hereinafter, an example of the operation of the authentication mechanism determination unit will be descried with reference to Table 1.

TABLE 1

| | | | | | | | | | Access |
|---|---|---|---|---|---|---|---|---|---|
| | Time | | IP | | Location | | Terminal | | Network |
| Rule | Analysis | | Analysis | | Analysis | | Analysis | | Analysis |
| Rule | 00:00~ | — | — | & | Foreign | — | — | — | — |
| 1-1 | 05:00 | | | | country | | | | |
| Rule | — | — | Domestic IP | & | Foreign | — | — | — | — |
| 1-2 | | | | | country | | | | |
| Rule | — | — | — | — | — | — | Unauthorized | \| | Unauthorized |
| 1-3 | | | | | | | terminal | | network |

Referring to Table 1, the authentication policy includes three rules in relation to the first analysis. The authentication policy may include Rule 1-1 for detecting a terminal which accesses a mobile cloud service from a foreign country in an early morning period (00:00˜05:00), Rule 1-2 for detecting a terminal which uses a domestic IP but accesses the mobile cloud service from a foreign country, and Rule 1-3 for detecting an unauthorized terminal or a terminal which accesses the mobile cloud service through an unauthorized network. Thus, when time information of the context information message is within 00:00˜05:00, the time analysis unit 235 may determine that the time information indicates the threat context and output one. When the IP/port item of the context information message identifies a domestic IP, the IP analysis unit 236 may determine that the IP indicates the threat context and output one. When the place item of the context information message identifies a foreign country, the location analysis unit 237 may determine that the place indicates the threat context and output one. When the terminal ID item of the context information message identifies an unauthorized terminal, the terminal analysis unit 238 may determine that the terminal indicates the threat context and output one. When the access network item of the context information message identifies an unauthorized network, the access network analysis unit 239 may determine that the network indicates the threat context and output one. Then, the authentication mechanism determination unit may perform the AND operation and the OR operation on Rules 1-1 through 1-3 and obtain results of the first analysis.

Additionally, the authentication mechanism determination unit may perform the second analysis, and a condition for the second analysis may be as follows.

Rule 2=Rule 1-1 & Rule 1-2|Rule 1-3 The authentication mechanism determination unit may combine the results of the first analysis through the second analysis and detect a terminal which accesses the mobile cloud service from a foreign country using a domestic IP in the early morning period (00:00˜05:00), an unauthorized terminal, or a terminal which accesses the mobile cloud service through an unauthorized access network.

After the analysis of the current context is completed as described above, the authentication mechanism determination unit may output a value of zero representing the safe context or a value of one representing the threat context as the analysis result of the current context and determine an authentication mechanism based on the analysis result of the current context. In some embodiments, when there is a possibility of illegal use of IDs, the authentication mechanism determination unit may determine to use a strong authentication mechanism such as a PKI certificate or a security card in addition to ID/PW. In some embodiments, the authentication mechanism determination unit may determine the type of authentication mechanism and determine the number of authentication mechanisms or the order in which the authentication mechanisms are applied.

The authentication mechanism determination unit may determine an authentication mechanism based on not only the analysis result of the current context but also a current authentication state. The current authentication state denotes information about an authentication method used by a user of the mobile terminal 100 to log in. The current authentication state may have a value of one if the user attempts to be authenticated for the first time in a current session, a value of two if the user who has already logged in attempts to be authenticated again using an ID/PW at the request of the context information-based authentication server 200, a value of three if the logged in user attempts to be authenticated again using a PKI certificate, and a value of four if the logged in user attempts to be authenticated again using a security card such as OTP.

The authentication mechanism determination unit may determine an authentication mechanism based on the analysis result of the current context and the analysis result of the current authentication state. For example, referring to FIG. 15, authentication mechanisms determined based on the current context and the current authentication state are shown in a table. For example, if the analysis result of the current context is zero representing the safe context and if the current authentication state is two, the authentication mechanism determination unit may determine ID/PW to be the authentication mechanism. In FIG. 15, a case where the authentication mechanism determination unit determines only the type of authentication mechanism based on the analysis result of the current context and the analysis result of the current authentication state is illustrated for ease of description. However, the authentication mechanism determination unit may also determine the number of authentication mechanisms or the order in which the authentication mechanisms are applied based on the analysis result of the current context and the analysis result of the current authentication state.

As the access environment of users become various, security threats have come to exist due to vulnerability of various terminals and access networks. Accordingly, it is required to authenticate a user by reflecting the access environment of the user. The reinforced authentication system 1000 using context information at the time of access to a mobile cloud service according to the embodiments of the present invention can determine the type of authentication based on a context information message, which reflects the access environment of a user, and an authentication policy and can use various authentication mechanisms. Thus, the reinforced authentication system 1000 can authenticate the user by reflecting the access environment of the user when the user attempts to access the mobile cloud service to use the service.

Referring back to FIG. 12, the authentication policy application demon 230 may include the PA-device module 233. The PA-device module 233 may determine whether to authenticate the mobile terminal 100 itself in addition to the user of the mobile terminal 100 based on the context information message and the authentication policy. For example, a mobile cloud service provider may distribute a terminal to each user and allow only the authorized terminal to access its mobile cloud service. Alternatively, the mobile cloud service provider may force each user to designate a certain terminal and use the designated terminal only. In this case, the terminals as well as the users may need to be authenticated. Accordingly, the authentication policy may include information about whether terminal authentication is required and information about authorized terminals. The PA-device module 233 may determine whether to execute terminal authentication by comparing the context information message and the authentication policy.

The PA-apply module 234 may receive the result of determining an authentication mechanism from the PA-context module 232 and information about whether to execute terminal authentication from the PA-device module 233 and transmit the received information to the authentication execution demon 220.

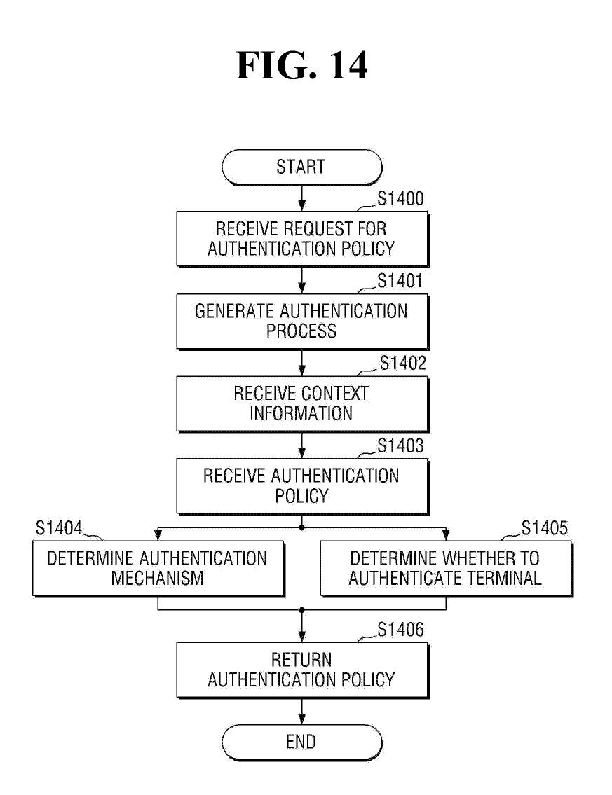

FIG. 14 is a flowchart illustrating the operation of the authentication policy application demon 230 included in the context information-based authentication server 200 of FIG. 2. The operation of the authentication policy application demon 230 described above with reference to FIGS. 12, 13 and 15 will now be described in greater detail with reference to FIG. 14.

Referring to FIG. 14, the authentication policy application demon 230 may receive a request for an authentication policy from the authentication execution demon 220 (operation S1400). Then, the application policy application demon 230 may generate an authentication process for determining an authentication mechanism (operation S1401), receive a context information message from the context information DB 240 (operation S1402), and receive an authentication policy from the authentication policy DB 250 (operation S1403). Next, the PA-context module 232 of the authentication policy application demon 230 may determine an authentication mechanism based on the context information message and the authentication policy (operation S1404). The PA-device module 234 of the authentication policy application demon 230 may determine whether to execute terminal authentication (operation S1405). Then, the PA-apply module 234 of the authentication policy application demon 230 may receive the determination results of the PA-context module 232 and the PA-device module 233 and return the authentication policy to the authentication execution demon 220 (operation S1406).

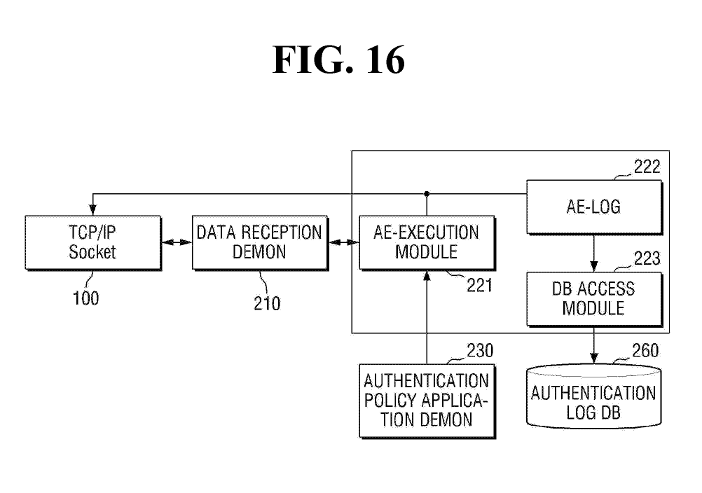

Referring back to FIGS. 1 and 2, the authentication execution demon 220 may authenticate a user of the mobile terminal 100 based on authentication information and an authentication mechanism. In the present specification, the authentication execution demon 220 may also be referred to as mobile cloud authentication—authentication execution (MCA-AE). The operation of the authentication execution demon 220 will now be described in more detail with reference to FIG. 16.

FIG. 16 is a schematic diagram illustrating the operation of the authentication execution demon 220 included in the context information-based authentication server 200 of FIG. 2. Referring to FIG. 16, the authentication execution demon 220 may include an AE-execution module 221, an AE-log 222, and a DB access module 223.

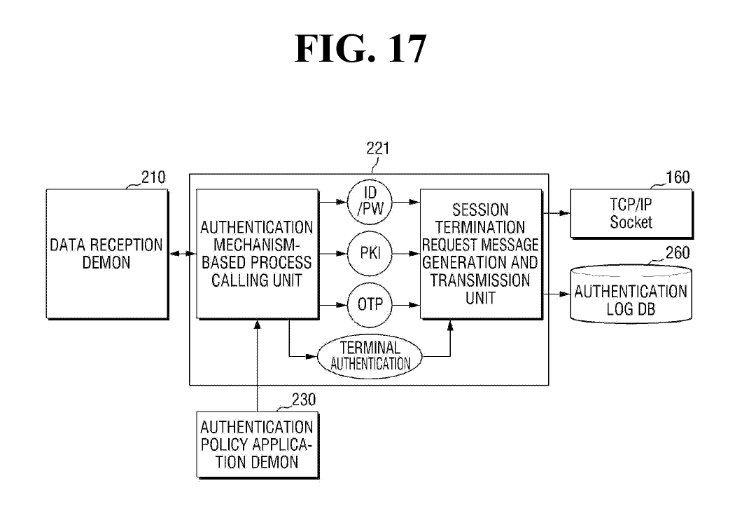

The AE-execution module 221 may authenticate a user of the mobile terminal 100 based on a context information message, authentication information, and an authentication mechanism. The authentication mechanism may include at least one of ID/PW authentication, PKI certificate authentication, and security card authentication. However, the present invention is not limited thereto. The operation of the AE-execution module 221 will now be described in more detail with reference to FIG. 17.

FIG. 17 is a schematic diagram illustrating the operation of the AE-execution module 221 included in the authentication execution demon 220 of the context information-based authentication server 200 of FIG. 2. Referring to FIG. 17, the AE-execution module 221 may include an authentication mechanism-based process calling unit, an authentication mechanism-based authentication execution unit, and a session termination request message generation and transmission unit.

The authentication mechanism-based process calling unit may receive from the authentication policy application demon 230 information about an authentication mechanism determined based on a context information message and an authentication policy. Then, the authentication mechanism-based process calling unit may receive authentication information related to the received authentication mechanism from the data reception demon 210. The authentication mechanism-based authentication execution unit may execute an authentication process for each authentication mechanism. For example, the authentication mechanism-based process calling unit may execute an ID/PW execution process, a PKI certificate authentication process, or a security card authentication process. When requested to execute terminal authentication by the authentication policy application demon 230, the authentication mechanism-based process calling unit may additionally execute a terminal authentication process.

When authentication is successful as a result of executing the above authentication process, the authentication execution demon 220 may issue an authentication token and store the authentication token in the AE-log 222. When authentication is not successful, the session termination request message generation and transmission unit of the authentication execution demon 220 may transmit a session termination request message for requesting session termination. In some embodiments, the session termination request message generation and transmission unit may transmit the session termination request message to the TCP/IP socket 160 of the mobile terminal 100.

Referring back to FIG. 16, the AE-log 222 may function as a temporary repository which stores log data about whether authentication is successful. Later, the AE-log 222 may be stored in the authentication log DB 260 by the DB access module 223.

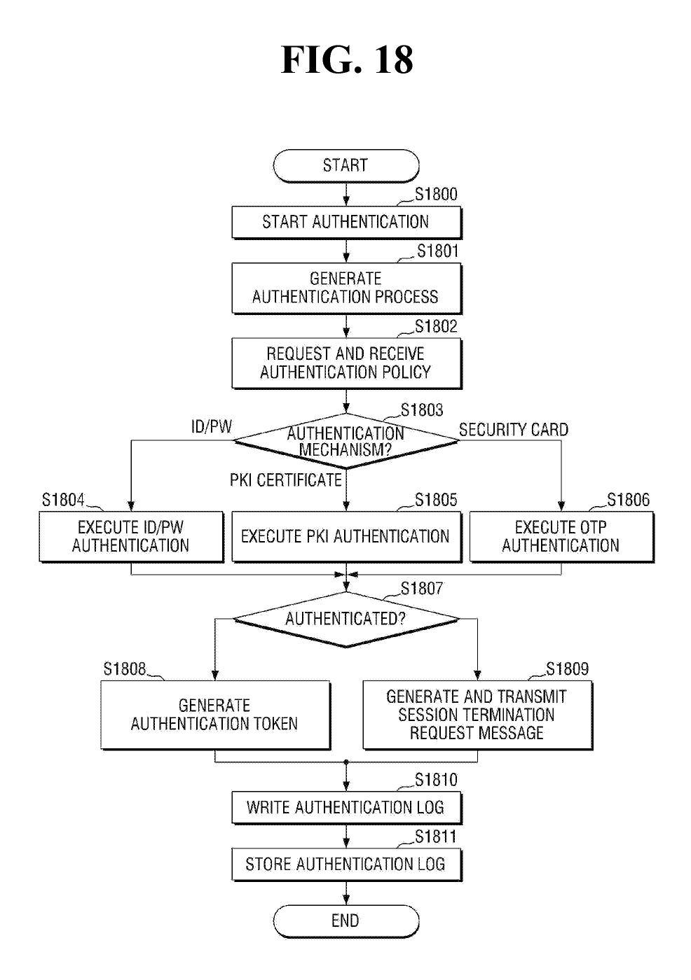

FIG. 18 is a flowchart illustrating the operation of the authentication execution demon 220 included in the context information-based authentication server 200 of FIG. 2. The operation of the authentication execution demon 220 described above with reference to FIGS. 16 and 17 will now be described in greater detail with reference to FIG. 18.

Referring to FIG. 18, the AE-execution module 221 of the authentication execution demon 220 may generate an authentication process for each authentication mechanism (operation S1801). Then, the AE-execution module 221 may request the authentication policy application demon 230 to provide an authentication policy and receive the authentication policy (operation S1802). The AE-execution module 221 may identify an authentication mechanism determined by the execution policy application demon 230 (operation S1803). According to the type of the authentication mechanism determined by the authentication policy application demon 230, the AE-execution module 221 may perform ID/PW authentication (operation S1804), PKI certificate authentication (operation S1805), or security card authentication (operation S1806). Then, the AE-execution module 221 may determine whether authentication is successful (operation S1807). When the authentication is successful, that is, when an authorized user accesses a mobile cloud service, the AE-execution module 221 may generate and issue an authentication token (operation S1808) and write the AE-log 222 (operation S1810). When the authentication is not successful, that is, when an unauthorized user accesses the mobile cloud service, the AE-execution module 221 may generate a session termination request message and transmit the generated session termination request message to the mobile terminal 100 (operation S1809) and write the AE-log 222 (operation S1810). Then, the written AE-log 222 may be stored in the authentication log DB 260 (operation S1811).

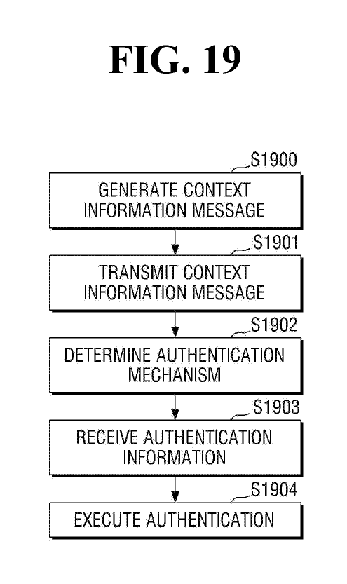

FIG. 19 is a flowchart illustrating a reinforced authentication method using context information at the time of access to a mobile cloud service according to an embodiment of the present invention.

Referring to FIG. 19, a mobile terminal may generate a context information message which includes context information (operation S1900) and transmit the generated context information message to a context information-based authentication server (operation S1901). The context information message may include a user ID item which identifies a user of the mobile terminal, an IP/port item which identifies an IP and port used by the mobile terminal, a time item which identifies a time when the context information was collected, a place item which identifies the location of the mobile terminal, a model name item of the mobile terminal, a terminal ID item of the mobile terminal, an access network item which identifies an access network to which the mobile terminal is connected, and an access network security item which indicates whether the access network applies encryption. When the access network item identifies the WiFi network, the context information message may further include an SSID item which identifies an SSID of the WiFi network. The context information message and the generation and transmission of the context information message are substantially the same as those described above with reference to FIGS. 1 through 18, and thus a repetitive description thereof will be omitted.

The context information-based authentication server may determine an authentication mechanism based on the context information message (operation S1902). The determining of the authentication mechanism may include comparing the context information message and an authentication policy. The comparing the context information message and the authentication policy may include comparing the time item of the context information message with an unallowed time range of the authentication policy, comparing the IP/port item of the context information message with an IP blacklist of the authentication policy, comparing the place item of the context information message with a place blacklist of the authentication policy, comparing the terminal ID item of the context information message with an unauthorized terminal list of the authentication policy, and comparing the access network item of the context information message with an unauthorized access network list of the authentication policy. Each of the above comparing processes may include outputting a value of zero in the case of a safe context and outputting a value of one in the case of a threat context.

The determining of the authentication mechanism may include determining an authentication mechanism based on the above output values. The determining of the authentication mechanism based on the output values may include determining an authentication mechanism by performing an AND operation or an OR operation on the output values. In some embodiments, the determining of the authentication mechanism may include determining an authentication mechanism based additionally on an authentication method used by the user of the mobile terminal to log in. The determining of the authentication mechanism is substantially the same as that described above with reference to FIGS. 1 through 18, and thus a repetitive description thereof will be omitted.

The context information-based authentication server may receive authentication information corresponding to the determined authentication mechanism from the mobile terminal (operation S1903) and execute authentication based on the authentication information and the authentication mechanism (operation S1904). The executing of the authentication is substantially the same as that described above with reference to FIGS. 1 through 18, and thus a repetitive description thereof will be omitted.

The reinforced authentication method using context information at the time of access to a mobile cloud service according to the current embodiment may further include generating a transmission interval change request message for the context information message and transmitting the generated transmission interval change request message to the mobile terminal. The generating and transmitting of the transmission interval change request message may include generating and transmitting a transmission interval change request message for the context information message when the items of the context information message received by the context information-based authentication server remain unchanged for a predetermined period of time, except for the time item. Requesting a change in the transmission interval of the context information message is substantially the same as that described above with reference to FIGS. 1 through 18, and thus a repetitive description thereof will be omitted.

Embodiments of the present invention provide at least one of the following advantages.

The embodiments of the present invention provide a mobile communication system and method in which a mobile communication system user is authenticated based on context information that reflects an access environment in which the user accesses a mobile cloud service.

In addition, the embodiments of the present invention provide a mobile communication system and method in which the number of authentication mechanisms used or the level of an authentication mechanism used is increased according to context information.

However, the effects of the present invention are not restricted to the one set forth herein. The above and other effects of the present invention will become more apparent to one of daily skill in the art to which the present invention pertains by referencing the claims.

What is claimed is:

1. A reinforced authentication system using context information at the time of access to a mobile cloud service, the system comprising:
a mobile terminal transmitting a context information message, which comprises context information, and authentication information; and
a context information-based authentication server receiving the context information message and the authentication information, determining an authentication mechanism based on the context information message, and authenticating a user of the mobile terminal,
wherein the context information message comprises a user ID item which identifies the user of the mobile terminal, an Internet protocol (IP)/port item which identifies an IP and port used by the mobile terminal, a time item which identifies a time when the context information was collected, a place item which identifies the location of the mobile terminal, a model name item of the mobile terminal, a terminal ID item of the mobile terminal, an access network item which identifies an access network to which the mobile terminal is connected, and an access network security item which indicates whether the access network applies encryption.

2. The reinforced authentication system of claim 1, wherein when the access network item identifies a WiFi network, the context information message further comprises a service set identifier (SSID) item which identifies an SSID of the WiFi network.

3. The reinforced authentication system of claim 1, wherein the mobile terminal comprises:
a context information collection module collecting the context information and generating the context information message; and
an authentication execution client module generating the authentication information which corresponds to an authentication mechanism requested by the context information-based authentication server.

4. The reinforced authentication system of claim 3, wherein the mobile terminal comprises a service client module to use a mobile cloud service.

5. The reinforced authentication system of claim 1, wherein the context information-based authentication server comprises:
a data reception demon receiving the context information message and the authentication information from the mobile terminal;
an authentication policy application demon determining the authentication mechanism based on the context information message and an authentication policy; and
an authentication execution demon executing authentication based on the authentication and the authentication mechanism.

6. The reinforced authentication system of claim 5, wherein the context information-based authentication server further comprises:
a context information database (DB) storing the context information message received from the mobile terminal;
an authentication policy DB storing the authentication policy; and
an authentication log DB storing an authentication result received from the authentication execution demon.

7. The reinforced authentication system of claim 6, wherein the data reception demon comprises:
a data classification module classifying the context information message and the authentication information and transmitting the authentication information to the authentication execution demon; and
a context information control module generating a transmission interval change request message for the context information message and transmitting the generated transmission interval change request message to the mobile terminal.

8. The reinforced authentication system of claim 7, wherein the context information control module transmits the transmission interval change request message for the context information message when the items of the context information message received by the data reception demon remain unchanged for a predetermined period of time, except for the time item.

9. The reinforced authentication system of claim 6, wherein the authentication execution demon comprises an authentication execution (AE)-execution module which authenticates the user of the mobile terminal based on the context information message, the authentication information, and the authentication mechanism, wherein the authentication mechanism comprises at least one of ID/password authentication, public key infrastructure (PKI) certificate authentication, and security card authentication.

10. The reinforced authentication system of claim 9, wherein the AE-execution module additionally authenticates the mobile terminal.

11. The reinforced authentication system of claim 6, wherein the authentication policy application demon comprises a policy adaption (PA)-context module which determines the authentication mechanism based on the context information message and the authentication policy, wherein the PA-context module comprises a time analysis unit, an IP analysis unit, a location analysis unit, a terminal analysis unit, an access network analysis unit, and an authentication mechanism determination unit.

12. The reinforced authentication system of claim 11, wherein each of the time analysis unit, the IP analysis unit, the location analysis unit, the terminal analysis unit, and the access network analysis unit compares the context information message and the authentication policy and outputs a value of zero in the case of a safe context and a value of one in the case of a threat context, and the authentication mechanism determination unit determines the authentication mechanism based on output values of the time analysis unit, the IP analysis unit, the location analysis unit, the terminal analysis unit, and the access network analysis unit.

13. The reinforced authentication system of claim 12, wherein the authentication mechanism determination unit determines the authentication mechanism by performing an AND operation or an OR operation on the output values of the time analysis unit, the IP analysis unit, the location analysis unit, the terminal analysis unit, and the access network analysis unit.

14. The reinforced authentication system of claim 12, wherein the authentication mechanism determination unit determines the authentication mechanism based additionally on an authentication method used by the user of the mobile terminal to log in.

15. The reinforced authentication system of claim 6, wherein the authentication policy application demon comprises a PA-device module which determines whether to authenticate the mobile terminal based on the context information message and the authentication policy.

16. A reinforced authentication method using context information at the time of access to a mobile cloud service, the method comprising:
generating a context information message, which comprises context information, by using a mobile terminal;
transmitting the context information message to a context information-based authentication server by using the mobile terminal;
determining an authentication mechanism based on the context information message by using the context information-based authentication server;
receiving authentication information, which corresponds to the authentication mechanism, from the mobile terminal by using the context information-based authentication server; and
executing authentication based on the authentication information and the authentication mechanism by using the context information-based authentication server,
wherein the context information message comprises a user ID item which identifies the user of the mobile terminal, an IP/port item which identifies an IP and port used by the mobile terminal, a time item which identifies a time when the context information was collected, a place item which identifies the location of the mobile terminal, a model name item of the mobile terminal, a terminal ID item of the mobile terminal, an access network item which identifies an access network to which the mobile terminal is connected, and an access network security item which indicates whether the access network applies encryption.

17. The reinforced authentication method of claim 16, wherein when the access network item identifies a WiFi network, the context information message further comprises an SSID item which identifies an SSID of the WiFi network.

18. The reinforced authentication method of claim 16, further comprising accessing a mobile cloud service using a service client module by using the mobile terminal when the mobile terminal is authenticated by the context information-based authentication server.

19. The reinforced authentication method of claim 16, wherein the determining of the authentication mechanism comprises comparing the context information message and an authentication policy.

20. The reinforced authentication method of claim 19, wherein the comparing of the context information message and the authentication policy comprises comparing the time item of the context information message with an unallowed time range of the authentication policy, comparing the IP/port item of the context information message with an IP blacklist of the authentication policy, comparing the place item of the context information message with a place blacklist of the authentication policy, comparing the terminal ID item of the context information message with an unauthorized terminal list of the authentication policy, and comparing the access network item of the context information message with an unauthorized access network list of the authentication policy.

21. The reinforced authentication method of claim 20, wherein each of the comparing of the time item of the context information message with the unallowed time range of the authentication policy, the comparing of the IP/port item of the context information message with the IP blacklist of the authentication policy, the comparing of the place item of the context information message with the place blacklist of the authentication policy, the comparing of the terminal ID item of the context information message with the unauthorized terminal list of the authentication policy, and the comparing of the access network item of the context information message with the unauthorized access network list of the authentication policy comprises outputting a value of zero in the case of a safe context and a value of one in the case of a threat context, and in the determining of the authentication mechanism, the authentication mechanism is determined based on the output values.

22. The reinforced authentication method of claim 21, wherein the determining of the authentication mechanism comprises determining the authentication mechanism by performing an AND operation or an OR operation on the output values.

23. The reinforced authentication method of claim 19, wherein the determining of the authentication mechanism comprises determining the authentication mechanism based additionally on an authentication method used by the user of the mobile terminal to log in.

24. The reinforced authentication method of claim 16, further comprising generating a transmission interval change request message for the context information message and transmitting the generated transmission interval change request message to the mobile terminal by using the context information-based authentication server.

25. The reinforced authentication method of claim 24, wherein the generating and transmitting of the transmission interval change request message comprises generating and transmitting the transmission interval change request message for the context information message when the items of the context information message received by the context information-based authentication server remain unchanged for a predetermined period of time, except for the time item.
